(19) United States
(12) Patent Application Publication
(10) Pub. No.: US 2026/0029545 A1
(43) Pub. Date: Jan. 29, 2026

(54) POSITIONING DEVICE

(71) Applicant: SEIKO EPSON CORPORATION, Tokyo (JP)

(72) Inventors: Hiroshi UOZUMI, MATSUMOTO-SHI (JP); Satoshi USUKURA, MATSUMOTO-SHI (JP)

(73) Assignee: SEIKO EPSON CORPORATION, Tokyo (JP)

(21) Appl. No.: 19/277,376

(22) Filed: Jul. 22, 2025

(30) Foreign Application Priority Data
Jul. 23, 2024 (JP) 2024-117859

(51) Int. Cl. G01S 19/32; G01S 19/34

(52) U.S. Cl. CPC G01S 19/32; G01S 19/34

(57) ABSTRACT

A positioning device, wherein a first integrated circuit includes a first reception unit converting a first satellite signal from a satellite into a first intermediate frequency signal, a first conversion unit converting the first intermediate frequency signal into a first baseband signal, a first baseband processing unit processing the first baseband signal, and a first control unit, a second integrated circuit includes a second reception unit converting a second satellite signal from the satellite into a second intermediate frequency signal, a second conversion unit converting the second intermediate frequency signal into a second baseband signal, and a second baseband processing unit processing the second baseband signal, and the first control unit switches the second reception unit, the second conversion unit, and the second baseband processing unit from an off state to an on state.

The present application is based on, and claims priority from JP Application Serial Number 2024-117859, filed Jul. 23, 2024, the disclosure of which is hereby incorporated by reference herein in its entirety.

### BACKGROUND

### 1. Technical Field

The present disclosure relates to a positioning device.

### 2. Related Art

WO 2019/155703 describes a satellite positioning signal reception device including a GNSS reception circuit that functions as a master and acquires navigation data in L1 and a satellite observation value, and a GNSS reception circuit that functions as a slave and acquires navigation data in L2/L5 and a satellite observation value, wherein the master GNSS reception circuit executes positioning calculation by using the navigation data in L1 and the satellite observation value that are acquired by the own circuit and the navigation data in L2/L5 and the satellite observation value that are transferred from the slave GNSS reception circuit.

According to the satellite positioning signal reception device described in WO 2019/155703, the two GNSS reception circuits collaborate to execute positioning, and hence the positioning time can be reduced. However, due to the high power consumption, the battery life is reduced.

### SUMMARY

According to an aspect of the present disclosure, a positioning device includes a first integrated circuit and a second integrated circuit, wherein the first integrated circuit includes a first reception unit configured to receive a first satellite signal transmitted from a satellite and converts the first satellite signal into a first intermediate frequency signal, a first conversion unit configured to convert the first intermediate frequency signal into a first baseband signal, a first baseband processing unit configured to process the first baseband signal, and a first control unit, the second integrated circuit includes a second reception unit configured to receive a second satellite signal transmitted from the satellite and convert the second satellite signal into a second intermediate frequency signal, a second conversion unit configured to convert the second intermediate frequency signal into a second baseband signal, and a second baseband processing unit configured to process the second baseband signal, and the first control unit switches the second reception unit, the second conversion unit, and the second baseband processing unit from an off state to an on state in accordance with a predetermined condition.

### BRIEF DESCRIPTION OF THE DRAWINGS

FIG. 1 is a diagram illustrating a configuration example of a positioning device of a first embodiment.

FIG. 2 is a diagram illustrating a configuration of a navigation message in the L1 band in GPS.

FIG. 3 is a diagram illustrating a configuration of a navigation message in the L5 band in GPS.

FIG. 4 is a timing chart diagram illustrating waveforms of various signals in a GNSS reception IC 10.

FIG. 5 is a timing chart diagram illustrating waveforms of various signals on the assumption that the GNSS reception IC 10 and a GNSS reception IC 20 are not synchronized with each other.

FIG. 6 is a timing chart diagram illustrating waveforms of various signals in the GNSS receptions IC 10 and 20.

FIG. 7 is a flowchart diagram illustrating an example of a procedure of processing by the GNSS reception IC 10 in the first embodiment.

FIG. 8 is a flowchart diagram illustrating an example of a procedure of processing by the GNSS reception IC 20 in the first embodiment.

FIG. 9 is a diagram illustrating a configuration example of the positioning device of a second embodiment.

FIG. 10 is a flowchart diagram illustrating an example of a procedure of processing by the GNSS reception IC 10 in the second embodiment.

FIG. 11 is a diagram illustrating a configuration of a modification example of the positioning device.

### DESCRIPTION OF EMBODIMENTS

A preferred embodiment of the present disclosure is described in detail below with reference to the drawings. Note that the embodiment to be described below does not unduly limit the content of the present disclosure described in the claims. In addition, not all configurations to be described below are essential constituent elements of the present disclosure.

### 1. First Embodiment

### 1-1. Configuration of Positioning Device

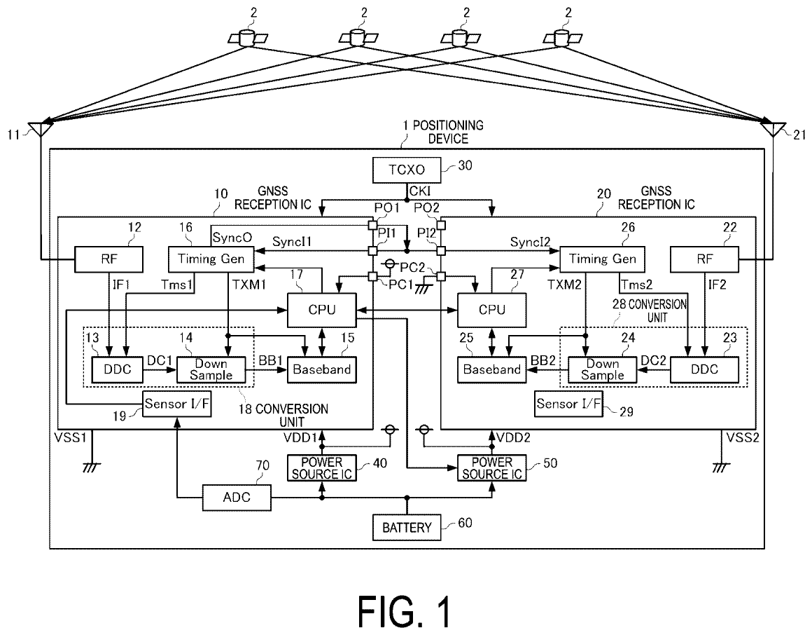

FIG. 1 is a diagram illustrating a configuration example of a positioning device 1 of a first embodiment. As the details thereof are described below, the positioning device 1 receives a satellite signal transmitted from a satellite 2, and executes positioning based on the received satellite signal.

As illustrated in FIG. 1, the positioning device 1 of the first embodiment includes GNSS reception ICs 10 and 20, antennas 11 and 21, a TCXO 30, power source ICs 40 and 50, a battery 60, and an ADC 70. However, the positioning device 1 of the first embodiment may be configured by omitting or changing some of the constituent elements in FIG. 1 or adding other constituent elements. GNSS is an abbreviation for Global Navigation Satellite System. IC is an abbreviation for Integrated Circuit. TCXO is an abbreviation for Temperature Compensated Crystal Oscillator. ADC is an abbreviation for Analog to Digital Converter.

The GNSS reception ICs 10 and 20 are operated by power supplied from the battery 60 via the power source ICs 40 and 50, respectively. In other words, the battery 60 is shared by the GNSS reception ICs 10 and 20. The battery 60 may be a primary battery or a secondary battery. The power source IC 40 converts an output voltage of the battery 60 into a predetermined DC voltage, and outputs the DC voltage as a power source voltage VDD1 to the GNSS reception IC 10. The power source IC 50 converts an output voltage of the battery 60 into a predetermined DC voltage, and outputs the DC voltage as a power source voltage VDD2 to the GNSS reception IC 20. The GNSS reception IC 10 is operated based on the power source voltage VDD1 and the ground voltage VSS1, and the GNSS reception IC 20 is operated based on the power source voltage VDD2 and a ground voltage VSS2.

The antennas 11 and 21 are antennas that receive various radio waves including a satellite signal transmitted from each of the plurality of satellites 2, and are coupled to the GNSS reception ICs 10 and 20, respectively. The GNSS reception ICs 10 and 20 receives a satellite signal transmitted from each of the plurality of satellites 2 via the antennas 11 and 21, respectively, and executes predetermined arithmetic processing, based on the received satellite signal.

The satellite 2 is an artificial satellite that orbits the Earth on a predetermined orbit and constitutes a part of GNSS. Examples of GNSS include GPS, QZSS, EGNOS, GLONASS, GALILEO, BeiDou, and the like. GPS is an abbreviation for Global Positioning System. QZSS is an abbreviation for Quasi Zenith Satellite System. EGNOS is an abbreviation for European Geostationary Navigation Overlay Service. GLONASS is an abbreviation for Global Navigation Satellite System. In the following description, an example where the satellite system to which the satellite 2 belongs is GPS is given.

The satellite 2 transmits satellite signals to the ground by superimposing navigation messages on radio waves in a plurality of frequency bands such as the L1 band having a center frequency of 1.57542 GHz and the L2 band having a center frequency of 1.22760 GHz. In GPS, there are approximately 30 satellites 2. In order to identify the satellite 2 that transmits a satellite signal, each of the satellites 2 superimposes a code with a unique 1023-chip pattern on the satellite signal in the L1 band. The code in the L1 band is referred to as a C/A code in which each chip is +1 or −1. The code appears as a random pattern, and is repeated with a 1 ms cycle. C/A is an abbreviation for Coarse/Acquisition Code.

Further, some of the satellites 2 transmit satellite signals to the ground by superimposing navigation messages on radio waves in the L5 band having a center frequency of 1.17645 GHz. Each of the satellites 2 superimposes a code with a unique 10230-chip pattern on the satellite signal in the L5 band. Similarly to the C/A code, in the code in the L5 band, each chip is +1 or −1. The code appears as a random pattern, and is repeated with a 1 ms cycle.

In the embodiment, the GNSS reception IC 10 and the GNSS reception IC 20 receive satellite signals in different frequency bands, and execute the arithmetic processing. For example, the frequency band of the satellite signal received by the GNSS reception IC 20 may be lower than the frequency band of the satellite signal received by the GNSS reception IC 10. In the following description, it is assumed that the GNSS reception IC 10 receives the satellite signal in the L1 band and the GNSS reception IC 20 receives the satellite signal in the L5 band being a frequency band lower than the L1 band. The GNSS reception IC 10 can detect the C/A code superimposed on the satellite signal in the L1 band by correlating the satellite signal with the pattern of each C/A code. Similarly, the GNSS reception IC 20 can detect the code superimposed on the satellite signal in the L5 band by correlating the satellite signal with the pattern of each code used in the L5 band.

The satellite signal transmitted from each of the satellites 2 includes orbit information indicating a position of each of the satellites 2 in the orbit. Further, an atomic clock is installed in each of the satellites 2, and the satellite signal includes highly accurate time information measured by the atomic clock. Therefore, in the positioning device 1, the GNSS reception ICs 10 and 20 collaborate to receive satellite signals from four or more satellites 2, and positioning calculation is executed by using the orbit information and the time information included in each of the satellite signals. In this manner, the accurate information relating to the position of the antennas 11 and 21 being a reception point and the time can be acquired. Specifically, the positioning device 1 may calculate a difference between the time of each of the satellites 2 and the time at the reception point by using the orbit information included in each of the satellite signals, may calculate a pseudo-distance between each of the satellites 2 and the reception point, based on the time difference, may formulate a four-dimensional equation with four variables including a three-dimensional position (x, y, z) of the reception point and a time t by using the pseudo-distance, and may obtain a solution thereof.

Note that a slight time error of the atomic clock installed in each of the satellites 2 is measured by a control segment on the ground, the satellite signal also includes a time correction parameter for correcting the time error, and the time at the reception point is corrected by using the time correction parameter. With this, the highly accurate time information can be acquired.

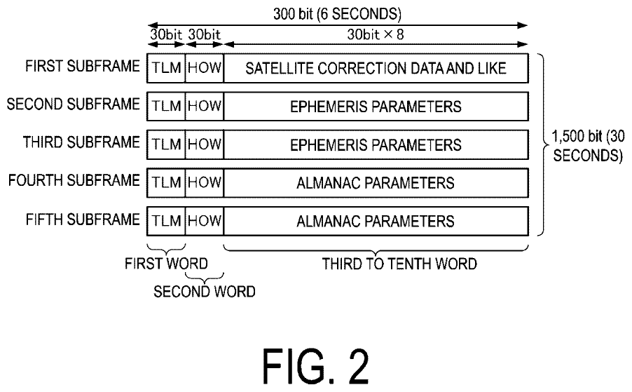

FIG. 2 is a diagram illustrating a configuration of a navigation message in the L1 band. As illustrated in FIG. 2, the navigation message in the L1 band is configured as data in which a main frame having a total of 1,500 bits serves as one unit. The main frame is divided, from the beginning, into five subframes including first to fifth subframes, and each of the subframes has 300 bits. One subframe of data is transmitted in six seconds from each satellite 2. Thus, one mainframe of data is transmitted from each satellite 2 in 30 seconds.

The 300-bit data included in each of the five subframes is divided, from the beginning, into first to tenth words, and each of the words has 30 bits. In each of the subframes, the first word is a TLM word, and the second word is a HOW word. TLM is an abbreviation for TeLeMetry, and HOW is an abbreviation for Hand Over Word. Therefore, the TLM word and the HOW word are transmitted from the satellite 2 at an interval of six seconds.

The TLM word includes preamble data, TLM message, reserved bits, and parity data.

The HOW word includes time information called TOW or Z count. TOW is an abbreviation for Time Of Week. The Z count data is displayed as the elapsed time in seconds from 00:00 on Sunday of each week, and is reset to 0 at 00:00 on the following Sunday. In other words, the Z count data is time information expressed in seconds for each week starting from the beginning of the week, and the elapsed time is represented in 1.5-second units. Herein, the Z count data indicates the time information when the first bit of the next subframe data is transmitted. For example, the Z count data in the first subframe indicates the time information when the first bit of the second subframe is transmitted. Further, the HOW word includes a 3-bit ID code indicating a subframe ID. In other words, the HOW words in the first to fifth subframes include ID codes “001”, “010”, “011”, “100”, and “101”, respectively. Based on week number data included in the first subframe and the HOW word in each of the subframes, the time of the satellite 2 can be calculated.

The third word to the tenth word in the first subframe include satellite correction data including a week number, a state of the satellite 2, a clock correction coefficient, and the like. In detail, the weak number and the state of the satellite 2 are included in the third word, and the clock correction coefficient is included in the eighth to tenth words. The third to tenth words in each of the second and third subframes includes ephemeris parameters being detailed orbit information relating to the satellite 2. The third to tenth words in each of the fourth and fifth subframes include almanac parameters being schematic orbit information relating to all the satellites 2. Therefore, the satellite correction data, the ephemeris parameters, and the almanac parameters are transmitted from the satellite 2 at an interval of 30 seconds.

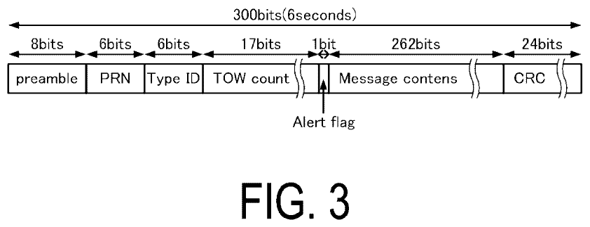

FIG. 3 is a diagram illustrating a configuration of a navigation message in the L5 band. As illustrated in FIG. 3, the navigation message in the L5 band is configured as data in which a 300-bit message serves as one unit, and is transmitted at an interval of six seconds. The 300-bit data that forms each message consists of an 8-bit preamble, a 6-bit satellite number PRN, a 6-bit message type ID, a 17-bit message TOW count, a 1-bit alert flag, a 262-bit message content, and a 24-bit CRC. CRC is an abbreviation for Cyclic Redundancy Check.

The message TOW count is a simplified 17-bit TOW count, and is expressed in a unit of 6 seconds. The actual TOW count is represented as the elapsed time from 00:00 on Sunday of each week in seconds, and is reset to 0 at 00:00 on the following Sunday. In other words, the actual TOW count is time information expressed in seconds for each week starting from the beginning of the week, and the elapsed time is represented in 1.5-second units. The message TOW count is a simplified version of the actual TOW count expressed in 17 bits.

The message content varies depending on the message type ID, and includes similar or corresponding information to that included in the navigation message in the L1 band.

Referring back to the description in FIG. 1, the GNSS reception IC 10 includes a control terminal PC1, and an input terminal PI1 and an output terminal PO1, and the GNSS reception IC 20 includes a control terminal PC2, and an input terminal PI2 and an output terminal PO2. The control terminal PC1 is a terminal for setting the GNSS reception IC 10 to a master or a slave, and the GNSS reception IC 10 is set to a master when the control terminal PC1 is at a high level, and is set to a slave when the control terminal PC1 is at a low level. The control terminal PC2 is a terminal for setting the GNSS reception IC 20 to a master or a slave, and the GNSS reception IC 20 is set to a master when the control terminal PC2 is at a high level, and is set to a slave when the control terminal PC2 is at a low level. A high-level voltage is input to one of the control terminals PC1 and PC2, and a low-level voltage is input to the other one. Therefore, one of the GNSS reception ICs 10 and 20 is set to a master, and the other one is set to a slave. In the embodiment, as illustrated in FIG. 1, the power source voltage VDD1 being a high-level voltage is input to the control terminal PC1, and the ground voltage VSS2 being a low-level voltage is input to the control terminal PC2. Therefore, the GNSS reception IC 10 is set to a master by the control terminal PC1, and the GNSS reception IC 20 is set to a slave by the control terminal PC2.

In the positioning device 1 of the embodiment, the GNSS reception IC 10 and the GNSS reception IC 20 can collaborate to execute positioning. In such a case, it is required to synchronize the arithmetic processing by the GNSS reception IC 10 and the arithmetic processing by the GNSS reception IC 20 with each other. The GNSS reception IC 10 being a master transmits a synchronization signal SyncO to the GNSS reception IC 20 being a slave via the output terminal PO1. In this manner, the output terminal PO1 is a terminal that outputs the synchronization signal SyncO to the outside of the GNSS reception IC 10. The GNSS reception IC 20 receives the synchronization signal SyncO as a synchronization signal SyncI2 via the input terminal PI2, and is synchronized with the synchronization signal SyncI2 to execute the arithmetic processing. In this manner, the input terminal PI2 is a terminal to which the synchronization signal SyncI2 is input from the outside of the GNSS reception IC 20. Note that the GNSS reception IC 20 is operated as a slave. Thus, there is no need to output the synchronization signal SyncO to the output terminal PO2, and the output terminal PO2 is not used.

Herein, the GNSS reception IC 10 and the GNSS reception IC 20 are mounted on a wiring substrate, which is omitted in illustration. Thus, the synchronization signal SyncO propagates through a wiring line that couples the output terminal PO1 of the GNSS reception IC 10 and the input terminal PI2 of the GNSS reception IC 20 to each other, and hence a delay occurs. Thus, a time difference occurs between the synchronization signal SyncO and the synchronization signal SyncI2. In view of this, in the embodiment, the GNSS reception IC 10 receives the synchronization signal SyncO as a synchronization signal SyncI1 via the input terminal PI1, and is synchronized with the synchronization signal SyncI1 to execute the arithmetic processing. In this manner, the input terminal PI1 is a terminal to which the synchronization signal SyncI1 is input from the outside of the GNSS reception IC 10.

The synchronization signal SyncO propagates through the wiring line that couples the output terminal PO1 and the input terminal PI1 of the GNSS reception IC 10 to each other on the wiring substrate. With this, a delay occurs, and a time difference occurs between the synchronization signal SyncO and the synchronization signal SyncI1. As a result, the time difference between the synchronization signal SyncI1 and the synchronization signal SyncI2 is reduced, and the synchronization accuracy between the arithmetic processing by the GNSS reception IC 10 and the arithmetic processing by the GNSS reception IC 20 is improved. As the time difference between the synchronization signal SyncO and the synchronization signal SyncI1 is closer to zero, the synchronization accuracy is higher. Thus, the length of the wiring line that couples the output terminal PO1 of the GNSS reception IC 10 and the input terminal PI2 of the GNSS reception IC 20 to each other may be equal to the length of the wiring line that couples the output terminal PO1 of the GNSS reception IC 10 and the input terminal PI1 of the GNSS reception IC 10 to each other.

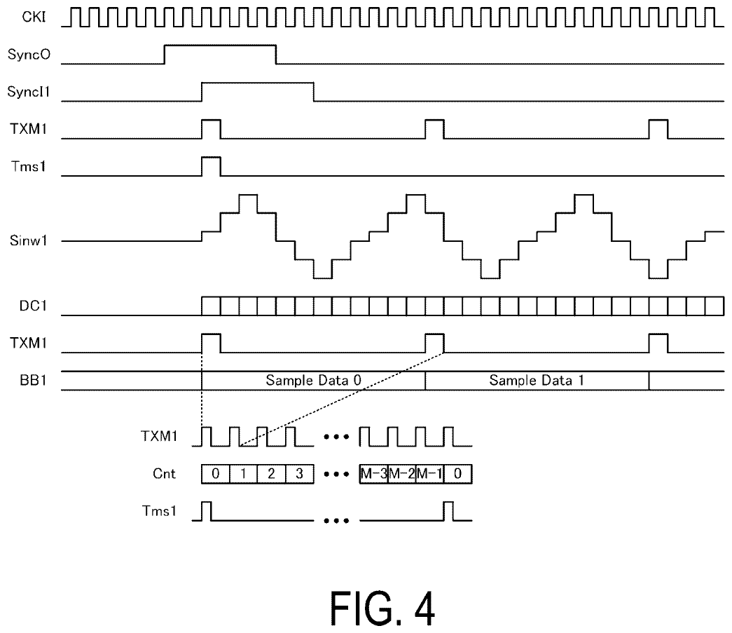

As illustrated in FIG. 1, the GNSS reception IC 10 includes an RF processing unit 12, a DDC 13, a down-sampling unit 14, a baseband processing unit 15, a timing signal generation unit 16, a CPU 17, and a sensor interface unit 19, and is operated based on a clock signal CKI that is output from the TCXO 30. RF is an abbreviation for Radio Frequency. DDC is an abbreviation for Digital Down Converter. CPU is an abbreviation for Central Processing Unit. The frequency of the clock signal CKI is, for example, several tens MHz. FIG. 4 is a timing chart diagram illustrating waveforms of various signals in the GNSS reception IC 10. The functions and operations of the respective units are described below as appropriate with reference to FIG. 4.

The CPU 17 determines whether the GNSS reception IC 10 is operated as a master or a slave, based on a logic level of a signal that is input from the control terminal PC1. In the embodiment, the high-level voltage is input from the control terminal PC1, and hence the CPU 17 operates the GNSS reception IC 10 as a master. Specifically, the CPU 17 controls the timing signal generation unit 16 to output the synchronization signal SyncO. Further, the CPU 17 is operated as a master during communication with the CPU 27 of the GNSS reception IC 20.

Under control of the CPU 17, the timing signal generation unit 16 outputs the synchronization signal SyncO. As illustrated in FIG. 4, the synchronization signal SyncO is a signal that is at a high level for a constant period, is output from the output terminal PO1 to the outside, and is input as the synchronization signal SyncI1 from the input terminal PI1. As illustrated in FIG. 4, the synchronization signal SyncI1 is a delayed version of the synchronization signal SyncO.

The timing signal generation unit 16 is synchronized with the synchronization signal SyncI1 to generate timing signals TXM1 and Tms1. As illustrated in FIG. 4, The timing signal TXM1 is a signal that is at a high level for a constant period at a predetermined cycle. Further, the timing signal Tms1 is a signal that defines 1 ms timing and is at a high level for a constant period every 1 ms. The timing signal generation unit 16 sets the timing signal Tms1 to a high level for a constant period each time the rising edge of the timing signal TXM1 is counted M times by an internal counter, which is omitted in illustration. The timing signal TXM1 is input to the down-sampling unit 14 and the baseband processing unit 15, and the timing signal Tms1 is input to the DDC 13.

The RF processing unit 12 receives the satellite signal in the L1 band that is transmitted from each of the satellites 2, and converts the received satellite signal into an intermediate frequency signal IF1. Specifically, the RF processing unit 12 extracts the satellite signal in the L1 band from the signal received by the antenna 11 by using a bandpass filter, amplifies the extracted satellite signal by an LNA, mixes the amplified signal and a clock signal obtained by multiplying the clock signal CKI by a PLL, and down-converts the mixed signal to a signal in an intermediate frequency band of several MHz, for example. LNA is an abbreviation for Low Noise Amplifier. PLL is an abbreviation for Phase Locked Loop. Then, the RF processing unit 12 subjects the signal in the intermediate frequency band to amplification and low-pass filtering processing, and then converts the resultant signal into a digital signal by an ADC. For example, the ADC subjects the signal in the intermediate frequency band to A/D conversion in a cycle of the clock signal CKI, and outputs a digital signal. The digital signal is input as the intermediate frequency signal IF1 to the DDC 13.

The DDC 13 is synchronized with the timing signal Tms1 to convert the intermediate frequency signal IF1 into a digital signal DC1 with a center frequency of 0 Hz. Specifically, as illustrated in FIG. 4, the DDC 13 is synchronized with the timing signal Tms1 to start generation of a digital signal Sinw1 of a sine wave with a frequency of several MHz, for example. The sampling rate of the digital signal Sinw1 of a sine wave is the same as the center frequency of the intermediate frequency signal IF1. The DDC 13 mixes the intermediate frequency signal IF1 with the digital signal Sinw1 of a sine wave, and then executes low-pass filtering processing to convert the mixed wave into the digital signal DC1 with a center frequency of 0 Hz. The sampling rate of the digital signal DC1 matches with the frequency of the clock signal CKI.

As illustrated in FIG. 4, the down-sampling unit 14 subjects the digital signal DC1 to down-sampling by the timing signal TXM1, and outputs a baseband signal BB1. The baseband signal BB1 is input to the baseband processing unit 15.

In this manner, the DDC 13 and the down-sampling unit 14 function as a conversion unit 18 that converts the intermediate frequency signal IF1 into the baseband signal BB1. Therefore, the timing signals Tms1 and TXM1 is a signal that controls operation timing of the conversion unit 18.

The baseband processing unit 15 is synchronized with the timing signal TXM1 to process the baseband signal BB1. Specifically, the baseband processing unit 15 generates a local code having the same pattern as each C/A code, and executes satellite search processing which correlates the local code with each C/A code contained in the baseband signal BB1. The satellite 2 moves at high speed. Thus, due to the Doppler effect, the frequency of the satellite signal in the L1 band that is received by the GNSS reception IC 10 fluctuates within a range of approximately ±2 kHz with respect to 1.57542 GHz. The fluctuation frequency, which is known as the Doppler frequency, results in a frequency offset in the satellite signal. Thus, the baseband processing unit 15 executes the satellite search processing while also taking into account the frequency offset of the satellite signal. Specifically, the baseband processing unit 15 adjusts a phase and a chip rate of the local code so that the correlation value with respect to each local code reaches a peak. When the correlation value is a threshold or more, it is determined that the local code is synchronized with the C/A code of the satellite 2, in other words, the satellite 2 is captured.

Note that GPS adopts a CDMA method where all the satellites 2 use different C/A codes and transmit satellite signals at the same frequency. Therefore, the baseband processing unit 15 can search for the satellite 2 that can be captured by identifying the C/A code included in the received satellite signal. CDMA is an abbreviation for Code Division Multiple Access.

When the satellite 2 is captured based on the baseband signal BB1, the baseband processing unit 15 calculates the frequency offset of the satellite signal, based on the chip rate, calculates the code phase, based on the phase of the local code, and generates satellite capture information including the frequency offset of the satellite signal and the code phase. Further, in the embodiment, the CPU 17 acquires satellite capture information generated by the baseband processing unit 25 of the GNSS reception IC 20, and outputs the acquired satellite capture information to the baseband processing unit 15. Further, when four or more satellites 2 can be captured, the baseband processing unit 15 demodulates the navigation message superimposed on the satellite signal transmitted from each of the satellites 2, based on the satellite capture information generated by the own unit and the satellite capture information generated by the baseband processing unit 25, and executes positioning computation. Specifically, the baseband processing unit 15 mixes the local code, which has the same pattern as the L1-band code of each of the captured satellites 2, with the baseband signal BB1 at an appropriate timing based on the frequency offset and the code phase that are included in the satellite signal included each piece of the satellite capture information, and demodulates the navigation message the orbit information and the time information that relate to each of the satellites 2. Further, the baseband processing unit 15 executes positioning by a publicly known method using the orbit information and the time information relating to the four or more satellites 2.

As illustrated in FIG. 1, the GNSS reception IC 20 includes a configuration similar to that of the GNSS reception IC 10, includes an RF processing unit 22, a DDC 23, a down-sampling unit 24, a baseband processing unit 25, a timing signal generation unit 26, a CPU 27, and a sensor interface unit 29, and is operated based on the clock signal CKI that is output from the TCXO 30. The names of the various signals in the GNSS reception IC 20 are different but similar to the names of the various signals in the GNSS reception IC 10. The timing chart illustrating the waveforms of the various signals in the GNSS reception IC 20 is similar to that in FIG. 4, and hence illustration thereof is omitted.

The CPU 27 determines whether the GNSS reception IC 20 is operated as a master or a slave, based on a logic level of a signal that is input from the control terminal PC2. In the embodiment, the low-level voltage is input from the control terminal PC2, and the CPU 27 operates the GNSS reception IC 20 as a slave. Specifically, the CPU 17 controls the timing signal generation unit 26 to receive the synchronization signal SyncO as the synchronization signal SyncI2. Further, the CPU 27 is operated as a slave during communication with the CPU 17 of the GNSS reception IC 10.

The synchronization signal SyncO that is output from the timing signal generation unit 16 of the GNSS reception IC 10 is input as the synchronization signal SyncI2 from the input terminal PI2 of the GNSS reception IC 20. The synchronization signal SyncI2 is a delayer version of the synchronization signal SyncO, and is a signal that is at a high level for a constant period at substantially the same timing with the synchronization signal SyncI1 illustrated in FIG. 4.

The timing signal generation unit 26 is synchronized with the synchronization signal SyncI2 to generate timing signals TXM2 and Tms2. The timing signal TXM2 is a signal that is at a high level for a constant period at a predetermined cycle. Further, the timing signal Tms2 is a signal that defines 1 ms timing and is at a high level for a constant period every 1 ms. The timing signal generation unit 26 sets the timing signal Tms2 to a high level for a constant period each time the rising edge of the timing signal TXM2 is counted N times by an internal counter, which is omitted in illustration. The timing signal TXM2 is input to the down-sampling unit 24 and the baseband processing unit 25, and the timing signal Tms2 is input to the DDC 23.

The RF processing unit 22 receives the satellite signal in the L5 band that is transmitted from each of the satellites 2, and converts the received satellite signal into an intermediate frequency signal IF2. Specifically, the RF processing unit 22 extracts the satellite signal in the L5 band from the signal received by the antenna 21 by using a bandpass filter, amplifies the extracted satellite signal by an LNA, mixes the amplified signal and a clock signal obtained by multiplying the clock signal CKI by a PLL, and down-converts the mixed signal to a signal in an intermediate frequency band several tens MHz, for example. Then, the RF processing unit 22 subjects the signal in the intermediate frequency band to amplification and low-pass filter processing, and then converts the resultant signal into a digital signal by an ADC. For example, the ADC subjects the signal in the intermediate frequency band to A/D conversion in a cycle of the clock signal CKI, and outputs a digital signal. The digital signal is input as the intermediate frequency signal IF2 to the DDC 23.

The DDC 23 is synchronized with the timing signal Tms2 to convert the intermediate frequency signal IF2 into a digital signal DC2 with a center frequency of 0 Hz. Specifically, the DDC 23 is synchronized with the timing signal Tms2 to start generation of a digital signal Sinw2 of a sine wave with a frequency of several tens MHz, for example. The sampling rate of the digital signal Sinw2 of a sine wave is the same as the center frequency of the intermediate frequency signal IF2. The DDC 23 mixes the intermediate frequency signal IF2 with the digital signal Sinw2 of a sine wave, and then executes low-pass filtering processing to convert the mixed wave into the digital signal DC2 with a center frequency of 0 Hz. The sampling rate of the digital signal DC2 matches with the frequency of the clock signal CKI.

The down-sampling unit 24 subjects the digital signal DC2 to down-sampling by the timing signal TXM2, and outputs a baseband signal BB2. The baseband signal BB2 is input to the baseband processing unit 25.

In this manner, the DDC 23 and the down-sampling unit 24 function as a conversion unit 28 that converts the intermediate frequency signal IF2 into the baseband signal BB2. Therefore, the timing signals Tms2 and TXM2 is a signal that controls operation timing of the conversion unit 28.

The baseband processing unit 25 is synchronized with the timing signal TXM2 to process the baseband signal BB2. Specifically, the baseband processing unit 25 generates a local code having the same pattern as each code in the L5 band, and executes satellite search processing which correlates the local code with each code contained in the baseband signal BB2. The satellite 2 moves at high speed. Thus, due to the Doppler effect, the frequency of the satellite signal in the L5 band that is received by the GNSS reception IC 20 fluctuates within a range of approximately ±2 kHz with respect to 1.17645 GHz. The fluctuation frequency, which is known as the Doppler frequency, results in a frequency offset in the satellite signal. Thus, the baseband processing unit 25 executes the satellite search processing while also taking into account the frequency offset of the satellite signal. Specifically, the baseband processing unit 25 adjusts a phase and a chip rate of the local code so that the correlation value with respect to each local code reaches a peak. When the correlation value is a threshold or more, it is determined that the local code is synchronized with the L5-band code of the satellite 2, in other words, the satellite 2 is captured.

When the satellite 2 is captured based on the baseband signal BB2, the baseband processing unit 25 calculates the frequency offset of the satellite signal, based on the chip rate, calculates the code phase, based on the phase of the local code, and generates satellite capture information including the frequency offset of the satellite signal and the code phase. In the embodiment, the baseband processing unit 25 does not execute positioning computation, and the GNSS reception IC 10 executes positioning computation by using the satellite capture information generated by the baseband processing unit 25. Thus, the GNSS reception IC 20 transmits the satellite capture information generated by the baseband processing unit 25 to the GNSS reception IC 10. Specifically, the CPU 27 of the GNSS reception IC 20 acquires the satellite capture information generated by the baseband processing unit 25, and transmits the acquired satellite capture information to the CPU 17 of the GNSS reception IC 10.

In this manner, in the embodiment, the GNSS reception IC 10 executes the arithmetic processing for the satellite signal in the L1 band, and the GNSS reception IC 20 executes the arithmetic processing for the satellite signal in the L5 band. The GNSS reception IC 10 and the GNSS reception IC 20 can collaborate to execute positioning. However, the chip rate of the code in the L5 band is ten times that of the chip rate of the code in the L1 band. Thus, the satellite capture accuracy of the baseband processing unit 25 is higher than that of the baseband processing unit 15, but the arithmetic load of the satellite capture by the baseband processing unit 25 is higher than that by the baseband processing unit 15. Therefore, the power consumption of the operations of the RF processing unit 22, the conversion unit 28, and the baseband processing unit 25 is more than the power consumption of the operations of the RF processing unit 12, the conversion unit 18, and the baseband processing unit 15. Thus, in the embodiment, in order to extend the battery life of the battery 60, the CPU 17 may set the RF processing unit 22, the conversion unit 28, and the baseband processing unit 25 to an off state, and the GNSS reception IC 10 may solely execute positioning.

In other words, the CPU 17 may set the RF processing unit 22, the conversion unit 28, and the baseband processing unit 25 of the GNSS reception IC 20 to an on state or an off state. Specifically, the CPU 17 controls an operation of the power source IC 50, and controls power supply from the battery 60 to the GNSS reception IC 20. In other words, the CPU 17 operates the power source IC 50 to supply power from the battery 60 to the GNSS reception IC 20 to set the RF processing unit 22, the conversion unit 28, and the baseband processing unit 25 to an on state. Further, the CPU 17 stops an operation of the power source IC 50 and stops power supply from the battery 60 to the GNSS reception IC 20 to set the RF processing unit 22, the conversion unit 28, and the baseband processing unit 25 to an off state.

In the embodiment, the CPU 17 switches the RF processing unit 22, the conversion unit 28, and the baseband processing unit 25 from an on state to an off state in accordance with a predetermined condition. Specifically, the CPU 17 acquires information relating to a remaining level of the battery 60 from the ADC 70 via the sensor interface unit 19. When the remaining level of the battery 60 is less than a threshold value, the RF processing unit 22, the conversion unit 28, and the baseband processing unit 25 are switched from an on state to an off state. For example, the ADC 70 may convert the output voltage of the battery 60 into a digital value. As the remaining level of the battery 60 is lower, the output voltage of the battery 60 is lower. In such a case, the CPU 17 can estimate the remaining level of the battery 60, based on the digital value that is output from the ADC 70. In a case in which the remaining level of the battery 60 is less than the threshold value, when the GNSS reception IC 10 and the GNSS reception IC 20 collaborate to execute positioning, the remaining level of the battery 60 may further be reduced, and there may be a risk that the operations of the GNSS reception ICs 10 and 20 are stopped before completion of positioning. Thus, in order to execute positioning solely by the GNSS reception IC 10 with relatively low power consumption, the CPU 17 stops an operation of the power source IC 50 and stops power supply from the battery 60 to the GNSS reception IC 20. With this, the CPU 17 switches the RF processing unit 22, the conversion unit 28, and the baseband processing unit 25 from an on state to an off state. As a result, the power consumption of the positioning device 1 is reduced, and the battery life of the battery 60 is extended.

Further, in the embodiment, the CPU 17 switches the RF processing unit 22, the conversion unit 28, and the baseband processing unit 25 from an off state to an on state in accordance with the predetermined condition. Specifically, the CPU 17 acquires the information relating to the remaining level of the battery 60 from the ADC 70 via the sensor interface unit 19. When the remaining level of the battery 60 is the threshold value or more, the RF processing unit 22, the conversion unit 28, and the baseband processing unit 25 are switched from an off state to an on state. When the remaining level of the battery 60 is the threshold value or more, the GNSS reception IC 10 and the GNSS reception IC 20 can collaborate to execute positioning. The CPU 17 operates the power source IC 50 to supply power from the battery 60 to the GNSS reception IC 20. With this, the CPU 17 switches the RF processing unit 22, the conversion unit 28, and the baseband processing unit 25 from an off state to an on state. Further, in the GNSS reception IC 10, the CPU 17 receives the satellite capture information generated by the baseband processing unit 25, the baseband processing unit 15 demodulates the navigation message included in the baseband signal BB1, based on the received satellite capture information, and positioning is executed based on the demodulated navigation message. Therefore, the baseband processing unit 15 is only required to execute minimum necessary satellite capture. Thus, the arithmetic load for satellite capture can be reduced, and the positioning time can be reduced.

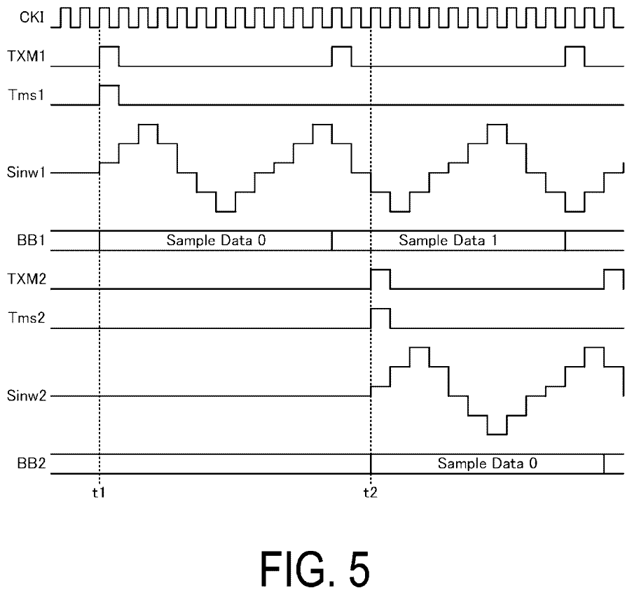

However, for example, when, hypothetically, the GNSS reception ICs 10 and 20 start the arithmetic processing at arbitrary timing, respectively, a time t1 at which the timing signal Tms1 rises and a time t2 at which the timing signal Tms2 rises do not match with each other as illustrated in FIG. 5. Consequently, data update timing of the baseband signal BB1 and data update timing of the baseband signal BB2 do not match with each other. Thus, the baseband processing unit 15 cannot accurately demodulate the navigation message superimposed on the baseband signal BB1, by using the satellite capture information that is generated by the baseband processing unit 25, based on the baseband signal BB2. In other words, it is required to synchronize the arithmetic processing of the GNSS reception IC 10 and the arithmetic processing of the GNSS reception IC 20 with each other so that the baseband processing unit 15 can accurately demodulate the navigation message, based on the satellite capture information generated by the baseband processing unit 25.

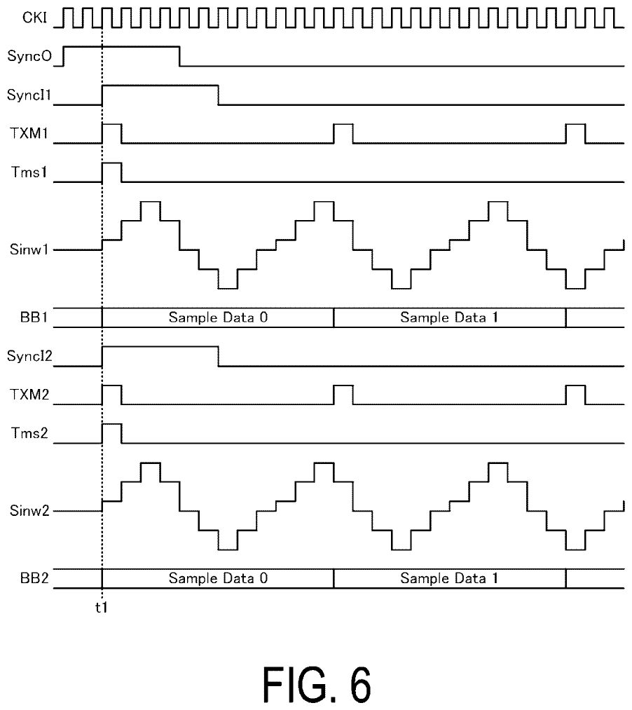

Thus, in the embodiment, the GNSS reception IC 10 switches the RF processing unit 22, the conversion unit 28, and the baseband processing unit 25 from an off state to an on state, and then transmits the synchronization signal SyncO to the GNSS reception IC 20 via the output terminal PO1. In other words, in the embodiment, as illustrated in FIG. 6, the GNSS reception IC 10 outputs the synchronization signal SyncO, and the GNSS reception ICs 10 and 20 start the arithmetic processing, based on the synchronization signals SyncI1 and SyncI2 that are respectively obtained by delaying the synchronization signal SyncO. With this, the timing signals Tms1 and Tms2 rise at the same time t1. Thus, the data update timing of the baseband signal BB1 and the data update timing of the baseband signal BB2 match with each other. Thus, the baseband processing unit 15 can accurately demodulate the navigation message superimposed on the baseband signal BB1, by using the satellite capture information that is generated by the baseband processing unit 25, based on the baseband signal BB2.

Note that, in the embodiment, the CPU 17 acquires the information relating to the remaining level of the battery 60 from the ADC 70 via the sensor interface unit 19. However, the CPU 27 may acquire the information relating to the remaining level of the battery 60 from the ADC 70 via the sensor interface unit 29, and the CPU 17 may acquire the information relating to the remaining level of the battery 60 from the CPU 27.

As illustrated in FIG. 1, the GNSS reception IC 10 and the GNSS reception IC 20 are integrated circuit with the same configuration in which a frequency band of a satellite signal to be received may be freely selected. The GNSS reception IC 10 may be set to receive the satellite signal in the L1 band, and the GNSS reception IC 20 may be set to receive the satellite signal in the L5 band. In this manner, when the GNSS reception ICs 10 and 20 are integrated circuit with the same configuration, the number of steps of developing the GNSS reception ICs 10 and 20 is reduced. However, the GNSS reception IC 10 and the GNSS reception IC 20 may not be integrated circuit with the same configuration. The GNSS reception IC 10 may be a configuration dedicated to reception of the satellite signal in the L1 band, and the GNSS reception IC 20 may be a configuration dedicated to reception of the satellite signal in the L5 band. Further, the GNSS reception IC 20 may not include the sensor interface unit 29. In this manner, when the GNSS reception ICs 10 and 20 are integrated circuits with configurations dedicated to reception of respective satellite signals in predetermined frequency bands, the size of each of the integrated circuits can be reduced.

Note that the GNSS reception IC 10 is an example of an “first integrated circuit”, and the GNSS reception IC 20 is an example of an “second integrated circuit”. The RF processing unit 12 is an example of a “first reception unit”, and the RF processing unit 22 is an example of a “second reception unit”. The conversion unit 18 is an example of a “first conversion unit”, and the conversion unit 28 is an example of a “second conversion unit”. The baseband processing unit 15 is an example of a “first baseband processing unit”, and the baseband processing unit 25 is an example of a “second baseband processing unit”. The CPU 17 is an example of a “first control unit”. The satellite signal in the L1 band that is received by the GNSS reception IC 10 is an example of a “first satellite signal”, and the satellite signal in the L5 band that is received by the GNSS reception IC 20 is an example of a “second satellite signal”. The intermediate frequency signal IF1 is an example of a “first intermediate frequency signal”, and the intermediate frequency signal IF2 is an example of a “second intermediate frequency signal”. The baseband signal BB1 is an example of a “first baseband signal”, and the baseband signal BB2 is an example of a “second baseband signal”. The timing signal Tms1 is an example of a “first timing signal”, and the timing signal Tms2 is an example of a “second timing signal”. The timing signal TXM1 is another example of the “first timing signal”, and the timing signal TXM2 is another example of the “second timing signal”.

### 1-2. Processing Procedure of Positioning Device

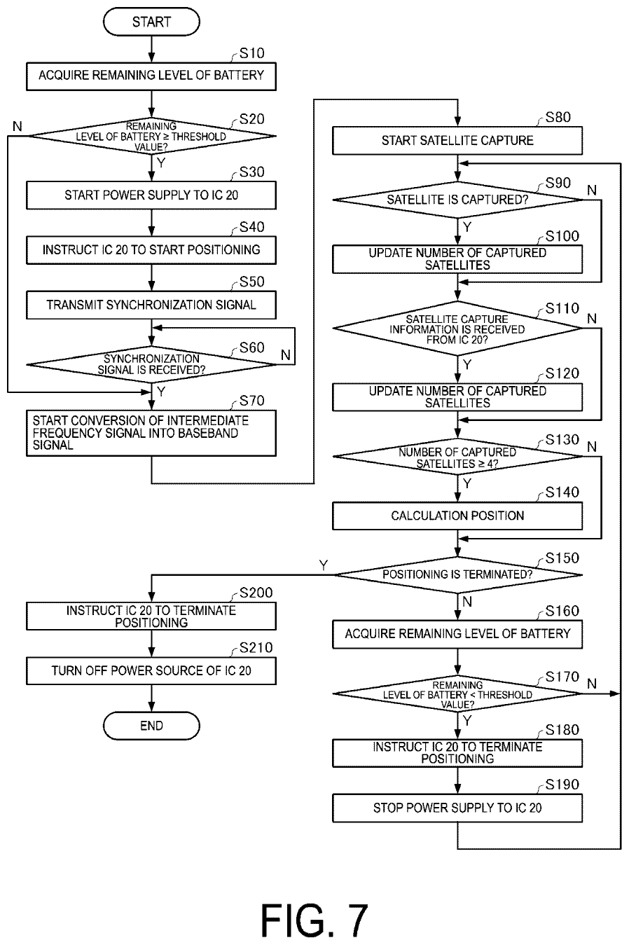

FIG. 7 is a flowchart diagram illustrating an example of a procedure of processing executed by the GNSS reception IC 10 in the first embodiment. As illustrated in FIG. 7, first, in step S10, the CPU 17 of the GNSS reception IC 10 acquires the remaining level of the battery 60. In step S20, the CPU 17 determines whether the remaining level of the battery 60 is the threshold value or more. Further, when the remaining level of the battery 60 is the threshold value or more in step S20, the CPU 17 switches the power source IC 50 from an off state to an on state, and starts power supply from the battery 60 to the GNSS reception IC 20 in step S30. With this, the RF processing unit 22, the conversion unit 28, and the baseband processing unit 25 of the GNSS reception IC 20 are switched from an off state to an on state.

Subsequently, in step S40, the CPU 17 instructs the GNSS reception IC 20 to start positioning. Subsequently, in step S50, the timing signal generation unit 16 of the GNSS reception IC 10 transmits the synchronization signal SyncO.

Subsequently, when the timing signal generation unit 16 receives the synchronization signal SyncI1 in step S60, the conversion unit 18 of the GNSS reception IC 10 is synchronized with the timing signals Tms1 and TXM1 based on the synchronization signal SyncI1 and starts conversion of the intermediate frequency signal IF1, which is output from the RF processing unit 12, into the baseband signal BB1 in step S70. Further, in step 80, the baseband processing unit 15 of the GNSS reception IC 10 is synchronized with the timing signal TXM1 to start capturing the satellite 2.

Note that, when the remaining level of the battery 60 is less than the threshold value in step S20, the GNSS reception IC 10 does not execute processing in step S30 to step S60.

Further, until positioning by the positioning device 1 is terminated in step 150, the number of satellites 2 captured in step S100 is updated every time the baseband processing unit 15 captures the satellite 2 in step S90. Further, every time the CPU 17 receives the satellite capture information from the CPU 27 of the GNSS reception IC 20 in step 110, the baseband processing unit 15 updates the number of captured satellites 2 in step S120. Further, when the number of captured satellites 2 is four or more in step S130, the baseband processing unit 15 calculates the position of the positioning device 1, based on the satellite capture information relating to the four or more captured satellites 2, in step S140.

Further, when positioning by the positioning device 1 is not terminated in step 150, the CPU 17 acquires the remaining level of the battery 60 in step S160. The CPU 17 determines whether the remaining level of the battery 60 is less than the threshold value in step S170. Further, when the remaining level of the battery 60 is less than the threshold value in step 170, the CPU 17 instructs the CPU 27 to terminate positioning in step S180. The CPU 17 switches the power source IC 50 from an on state to an off state, and stops power supply from the battery 60 to the GNSS reception IC 20 in step S190. With this, the RF processing unit 22, the conversion unit 28, and the baseband processing unit 25 of the GNSS reception IC 20 are switched from an on state to an off state. Further, the GNSS reception IC 10 re-executes the processing after step S90.

When positioning by the positioning device 1 is terminated in step S150, the CPU 17 also instructs the CPU 27 to terminate processing in step S200. The CPU 17 also switches the power source IC 50 from an on state to an off state, and stops power supply from the battery 60 to the GNSS reception IC 20 in step S210. With this, the RF processing unit 22, the conversion unit 28, and the baseband processing unit 25 of the GNSS reception IC 20 are switched from an on state to an off state. Further, the processing of the GNSS reception IC 10 is terminated.

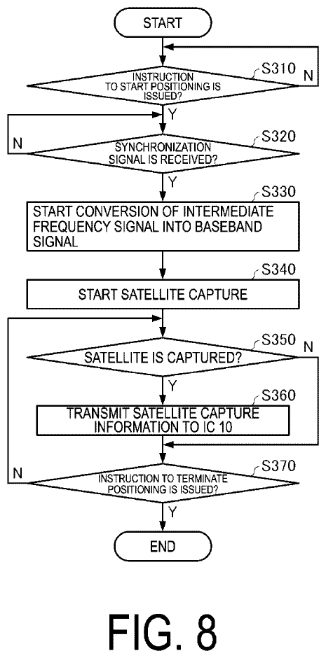

FIG. 8 is a flowchart diagram illustrating an example of a procedure of processing executed by the GNSS reception IC 20 in the first embodiment. As illustrated in FIG. 8, first, in step S310, the CPU 27 of the GNSS reception IC 20 stands by until the CPU 17 of the GNSS reception IC 10 issues an instruction to start positioning. When the instruction to start positioning is issued, the timing signal generation unit 26 of the GNSS reception IC 20 stands by until the synchronization signal SyncI2 is received in step S320.

Further, when the timing signal generation unit 26 receives the synchronization signal SyncI2 in step 320, the conversion unit 28 of the GNSS reception IC 20 is synchronized with the timing signals Tms2 and TXM2 based on the synchronization signal SyncI2, and starts conversion of the intermediate frequency signal IF2, which is output from the RF processing unit 22, into the baseband signal BB2 in step S330. Further, in step 340, the baseband processing unit 25 of the GNSS reception IC 20 is synchronized with the timing signal TXM2 to start capturing the satellite 2.

Further, until the CPU 27 receives an instruction to terminate positioning from the CPU 17 in step 370, the CPU 27 transmits the satellite capture information to the CPU 17 of the GNSS reception IC 10 in step S360 every time the baseband processing unit 25 captures the satellite 2 in step S350.

Finally, when the CPU 27 receives the instruction to terminate positioning from the CPU 17, the processing of the GNSS reception IC 20 is terminated in step S370.

### 1-3. Actions and Effects

As described above, according to the positioning device 1 of the first embodiment, the RF processing unit 22, the conversion unit 28, and the baseband processing unit 25 are switched from an off state to an on state in accordance with the predetermined condition. With this, the GNSS reception IC 10 and the GNSS reception IC 20 can collaborate to execute positioning. Specifically, when the remaining level of the battery 60 that is shared by the GNSS reception ICs 10 and 20 is the threshold value or more, the RF processing unit 22, the conversion unit 28, and the baseband processing unit 25 are switched from an off state to an on state. With this, the GNSS reception IC 10 and the GNSS reception IC 20 can collaborate to execute positioning, and hence the probability of successful positioning is increased.

Further, according to the positioning device 1 of the first embodiment, the RF processing unit 22, the conversion unit 28, and the baseband processing unit 25 are switched from an on state to an off state in accordance with the predetermined condition. With this, the GNSS reception IC 10 solely executes positioning. Thus, the power consumption of the positioning device 1 can be reduced, and the battery life of the battery 60 can be expanded. Specifically, when the remaining level of the battery 60 is less than the threshold value, the RF processing unit 22, the conversion unit 28, and the baseband processing unit 25 are switched from an on state to an off state. With this, the GNSS reception IC 10 solely executes positioning. Thus, the battery life of the battery 60 can be expanded.

Further, according to the positioning device 1 of the first embodiment, due to the synchronization signal SyncO that is output from the GNSS reception IC 10, the timing at which the GNSS reception IC 10 receives the satellite signal in the L1 band to extract the baseband signal BB1 and the timing at which the GNSS reception IC 20 receives the satellite signal in the L5 band to extract the baseband signal BB2 can be synchronized with each other. Specifically, due to the synchronization signals SyncI1 and SyncI2 that are obtained by delaying the synchronization signal SyncO, the timing at which the conversion unit 18 converts the intermediate frequency signal IF1, which is output from the RF processing unit 12 into the baseband signal BB1 and the timing at which the conversion unit 28 converts the intermediate frequency signal IF2, which is output from the RF processing unit 22, into the baseband signal BB2 can match with each other. Therefore, according to the positioning device 1 of the first embodiment, the GNSS reception IC 10 and the GNSS reception IC 20 can collaborate to search for each of the satellites 2 efficiently. Thus, power saving and time reduction during the search are achieved.

Further, according to the positioning device 1 of the first embodiment, the length of the wiring line that couples the output terminal PO1 of the GNSS reception IC 10 and the input terminal PI2 of the GNSS reception IC 10 to each other and the length of the wiring line that couples the output terminal PO1 and the input terminal PI1 of the GNSS reception IC 20 to each other are equal to each other. Thus, the time from timing at which the synchronization signal SyncO is output from the output terminal PO1 to the timing at which the synchronization signal SyncO is input to the input terminals PI1 and PI12 can be aligned. Consequently, the operation timing of the conversion unit 18 and the operation timing of the conversion unit 28 can be synchronized with each other more accurately.

Further, according to the positioning device 1 of the first embodiment, the GNSS reception IC 10 that receives the satellite signal in the L1 band serves as a master, and the GNSS reception IC 20 that receives the satellite signal in the L5 band serves as a slave. With this, the satellite 2 can be captured efficiently by receiving the satellite signals in the different frequency bands, and the GNSS reception IC 10 can execute positioning for a short period of time by utilizing the satellite capture information generated by the GNSS reception IC 20.

### 2. Second Embodiment

The positioning device 1 of a second embodiment is described below while the configurations thereof that are similar to those in the first embodiment are denoted with the same reference symbols, and the description similar to that for the first embodiment is omitted or simplified. The differences from the contents in the first embodiment are mainly described.

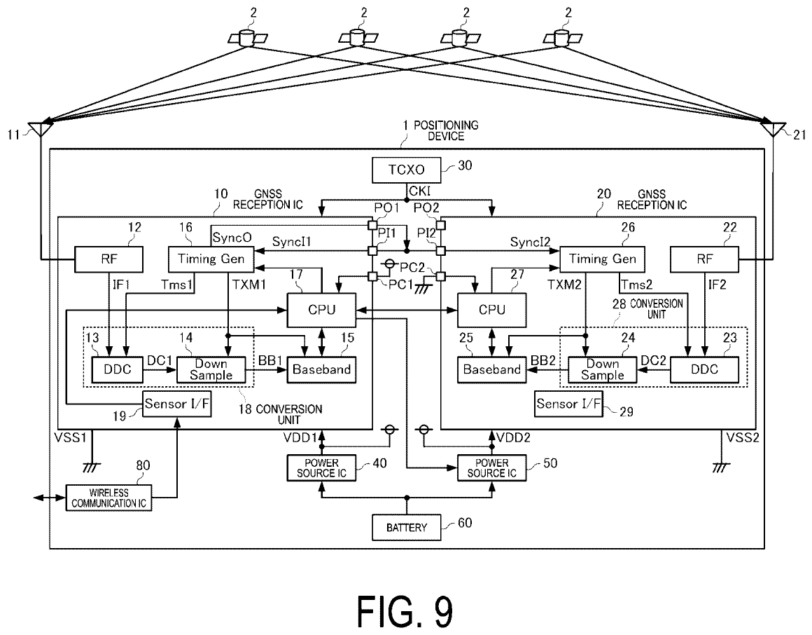

FIG. 9 is a diagram illustrating a configuration example of the positioning device 1 of a second embodiment. The constituent elements in FIG. 9 that are similar to those in FIG. 1 are denoted with the same reference symbols. As illustrated in FIG. 9, the positioning device 1 of the second embodiment includes the GNSS reception ICs 10 and 20, the antennas 11 and 21, the TCXO 30, the power source ICs 40 and 50, the battery 60, and a wireless communication IC 80. However, the positioning device 1 of the second embodiment may be configured by omitting or modifying some of the constituent elements in FIG. 9 or adding other constituent elements. The configurations and the functions of the GNSS reception IC 20, the antennas 11 and 21, the TCXO 30, the power source ICs 40 and 50, and the battery 60 are similar to those in the first embodiment, and hence description therefor is omitted. Further, the functions of the RF processing unit 12, the DDC 13, the down-sampling unit 14, the baseband processing unit 15, and the timing signal generation unit 16 of the GNSS reception IC 10 similar to those in the first embodiment, and hence the description therefor is omitted.

Similarly to the first embodiment, in the second embodiment, the CPU 17 sets the RF processing unit 22, the conversion unit 28, and the baseband processing unit 25 of the GNSS reception IC 20 to an on state or an off state. Specifically, the CPU 17 controls an operation of the power source IC 50, and controls power supply from the battery 60 to the GNSS reception IC 20. In other words, the CPU 17 operates the power source IC 50 to supply power from the battery 60 to the GNSS reception IC 20 to set the RF processing unit 22, the conversion unit 28, and the baseband processing unit 25 to an on state. Further, the CPU 17 stops an operation of the power source IC 50 and stops power supply from the battery 60 to the GNSS reception IC 20 to set the RF processing unit 22, the conversion unit 28, and the baseband processing unit 25 to an off state.

In the embodiment, the CPU 17 switches the RF processing unit 22, the conversion unit 28, and the baseband processing unit 25 from an on state to an off state in accordance with a predetermined condition. Specifically, the CPU 17 acquires information relating to signal strength of the wireless communication from the wireless communication IC 80 via the sensor interface unit 19. The wireless communication IC 80 executes the wireless communication with an external device, which is omitted in illustration, in accordance with the communication standard such as LPWA and Wi-Fi (registered trademark). When the communication strength of the wireless communication is more than a threshold value, the RF processing unit 22, the conversion unit 28, and the baseband processing unit 25 are switched from an on state to an off state. When the communication strength of the wireless communication is more than the threshold value, the reception environment for wireless radio waves is satisfactory. Thus, it is also conceived that the reception environment for the satellite signals in the GNSS reception IC 10 is satisfactory. Thus, positioning can be executed solely by the GNSS reception IC 10, the CPU 17 stops an operation of the power source IC 50, and stops power supply from the battery 60 to the GNSS reception IC 20. With this, the CPU 17 switches the RF processing unit 22, the conversion unit 28, and the baseband processing unit 25 from an on state to an off state. As a result, the power consumption of the positioning device 1 is reduced, and the battery life of the battery 60 is extended.

Further, in the embodiment, the CPU 17 switches the RF processing unit 22, the conversion unit 28, and the baseband processing unit 25 from an off state to an on state in accordance with the predetermined condition. Specifically, the CPU 17 acquires the information relating to the signal strength of the wireless communication from the wireless communication IC 80 via the sensor interface unit 19. When the communication strength of the wireless communication is the threshold value or less, the RF processing unit 22, the conversion unit 28, and the baseband processing unit 25 are switched from an off state to an on state. When the communication strength of the wireless communication is the threshold value or less, the reception environment for wireless radio waves is not satisfactory. Thus, it is also conceived that the reception environment for the satellite signals in the GNSS reception IC 10 is not satisfactory. Thus, the probability that positioning executed solely by the GNSS reception IC 10 is terminated within a short period of time is low. Thus, the CPU 17 operates the power source IC 50 to supply power from the battery 60 to the GNSS reception IC 20 so that the GNSS reception IC 10 and the GNSS reception IC 20 collaborate to execute positioning. With this, the CPU 17 switches the RF processing unit 22, the conversion unit 28, and the baseband processing unit 25 from an off state to an on state. Further, in the GNSS reception IC 10, the CPU 17 receives the satellite capture information generated by the baseband processing unit 25, the baseband processing unit 15 demodulates the navigation message included in the baseband signal BB1, based on the received satellite capture information, and positioning is executed based on the demodulated navigation message. Therefore, the baseband processing unit 15 is only required to execute minimum necessary satellite capture. Thus, the arithmetic load for satellite capture can be reduced, and the positioning time can be reduced.

Note that, in the embodiment, the CPU 17 acquires the information relating to the signal strength of the wireless communication from the wireless communication IC 80 via the sensor interface unit 19. Alternatively, the CPU 27 may acquire the information relating to the signal strength of the wireless communication from the wireless communication IC 80 via the sensor interface unit 29, and the CPU 17 may acquire the information relating to the signal strength of the wireless communication from the CPU 27.

The rest of the configurations and the functions of the positioning device 1 of the second embodiment is similar to those in the first embodiment, and hence the description therefor is omitted. Note that the wireless communication IC 80 is an example of a “third integrated circuit”.

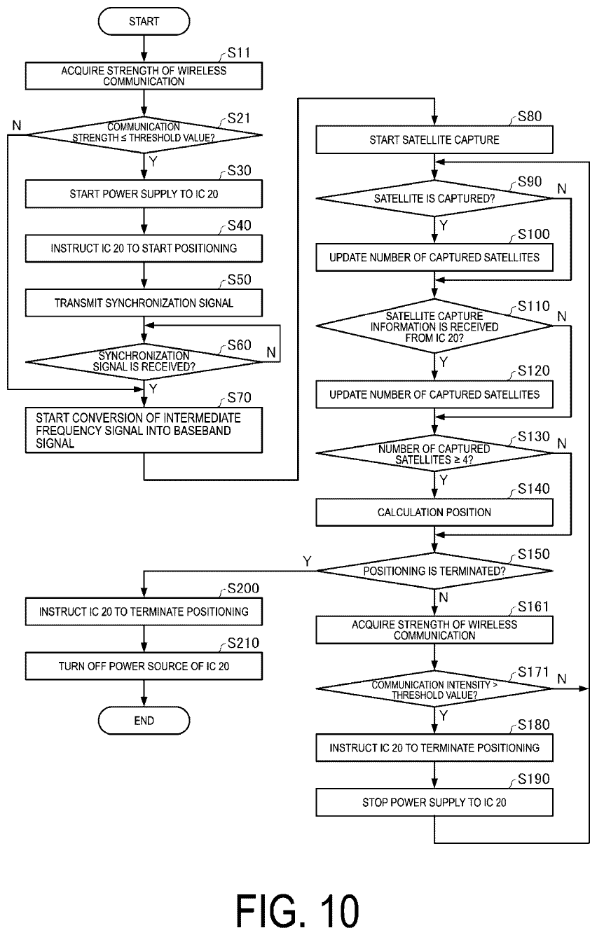

FIG. 10 is a flowchart diagram illustrating an example of a procedure of processing executed by the GNSS reception IC 10 in the second embodiment. The steps in FIG. 10 that are similar to those in FIG. 7 are denoted with the same reference symbols. As illustrated in FIG. 10, first, in step S11, the CPU 17 of the GNSS reception IC 10 acquires the strength of the wireless communication executed by the wireless communication IC 80. In step S21, the CPU 17 determines whether the strength of the wireless communication is the threshold value or less. Further, when the strength of the wireless communication is the threshold value or less in step 21, the CPU 17 switches the power source IC 50 from an off state to an on state, and starts power supply from the battery 60 to the GNSS reception IC 20 in step S30. With this, the RF processing unit 22, the conversion unit 28, and the baseband processing unit 25 of the GNSS reception IC 20 are switched from an off state to an on state.

Further, similarly to the first embodiment, the GNSS reception IC 10 executes the processing in step S40 to step S80. Note that, when the strength of the wireless communication is more than the threshold value in step S21, the GNSS reception IC 10 does not execute the processing in step S30 to step S60.

Further, the GNSS reception IC 10 executes the processing in step S90 to step S140 until positioning by the positioning device 1 is terminated in step 150. Further, when positioning by the positioning device 1 is not terminated in step 150, the CPU 17 acquires the strength of the wireless communication in step S161, and the CPU 17 determines whether the strength of the wireless communication is more than the threshold value in step S171. Further, when the strength of the wireless communication is more than the threshold value in step 171, the CPU 17 instructs the CPU 27 to terminate positioning in step S180, and the CPU 17 switches the power source IC 50 from an on state to an off state, and stops power supply from the battery 60 to the GNSS reception IC 20 in step S190. With this, the RF processing unit 22, the conversion unit 28, and the baseband processing unit 25 of the GNSS reception IC 20 are switched from an on state to an off state. Further, the GNSS reception IC 10 re-executes the processing after step S90.

When positioning by the positioning device 1 is terminated in step S150, the CPU 17 also instructs the CPU 27 to terminate processing in step S200. The CPU 17 also switches the power source IC 50 from an on state to an off state, and stops power supply from the battery 60 to the GNSS reception IC 20 in step S210. With this, the RF processing unit 22, the conversion unit 28, and the baseband processing unit 25 of the GNSS reception IC 20 are switched from an on state to an off state. Further, the processing of the GNSS reception IC 10 is terminated.

The procedure of the processing executed by the GNSS reception IC 20 in the second embodiment is similar to that in FIG. 8, and hence illustration and description therefor re omitted.

As described above, according to the positioning device 1 of the second embodiment, the RF processing unit 22, the conversion unit 28, and the baseband processing unit 25 are switched from an off state to an on state in accordance with the predetermined condition. With this, the GNSS reception IC 10 and the GNSS reception IC 20 can collaborate to execute positioning. Specifically, when the communication strength is not satisfactory, and the communication strength of the wireless communication by the wireless communication IC 80 is the threshold value or less, the RF processing unit 22, the conversion unit 28, and the baseband processing unit 25 are switched from an off state to an on state. With this, the GNSS reception IC 10 and the GNSS reception IC 20 can collaborate to execute positioning, and hence the probability of successful positioning is increased.

Further, according to the positioning device 1 of the second embodiment, the RF processing unit 22, the conversion unit 28, and the baseband processing unit 25 are switched from an on state to an off state in accordance with the predetermined condition. With this, the GNSS reception IC 10 solely executes positioning. Thus, the power consumption of the positioning device 1 can be reduced, and the battery life of the battery 60 can be expanded. Specifically, when the communication strength is satisfactory, and the communication strength of the wireless communication is more than the threshold value, the RF processing unit 22, the conversion unit 28, and the baseband processing unit 25 are switched from an on state to an off state. With this, the GNSS reception IC 10 solely executes positioning. Thus, the battery life of the battery 60 can be expanded.

In addition, the positioning device 1 of the second embodiment exerts effects similar to those of the positioning device 1 of the first embodiment.

### 3. Modification Example

The present disclosure is not limited to the present embodiment, and various modifications can be made within the scope of the present disclosure.

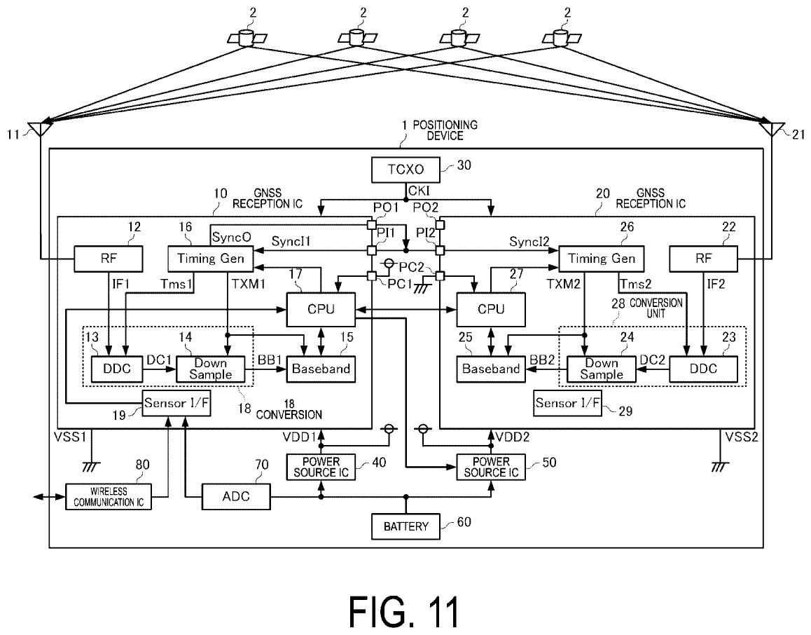

For example, the positioning device 1 of the first embodiment includes the ADC 70 as illustrated in FIG. 1, and the positioning device 1 of the second embodiment includes the wireless communication IC 80 as illustrated in FIG. 9. Alternatively, as illustrated in FIG. 11, the positioning device 1 may include both the ADC 70 and the wireless communication IC 80. In such a case, the CPU 17 may acquire the information relating to the remaining level of the battery 60 from the ADC 70 via the sensor interface unit 19, acquire the information relating to the signal strength of the wireless communication from the wireless communication IC 80, and set the RF processing unit 22, the conversion unit 28, and the baseband processing unit 25 to an off state, based on the remaining level of the battery 60 and the signal strength of the wireless communication. For example, when the remaining level of the battery 60 is less than the threshold value, or the signal strength of the wireless communication is more than the threshold value, the CPU 17 may switch the RF processing unit 22, the conversion unit 28, and the baseband processing unit 25 from an on state to an off state. Further, for example, when the remaining level of the battery 60 is the threshold value or more, and the signal strength of the wireless communication is the threshold value or less, the CPU 17 may switch the RF processing unit 22, the conversion unit 28, and the baseband processing unit 25 from an off state to an on state.

Further, in each of the above-mentioned embodiments, the description is made while assuming that the GNSS reception IC 10 executes the arithmetic processing with respect to the satellite signal in the L1 band, and the GNSS reception IC 20 executes the arithmetic processing with respect to the satellite signal in the L5 band. The frequency bands of the satellite signals subjected to the arithmetic processing of the GNSS reception ICs 10 and 20 are not limited thereto. For example, the GNSS reception IC 10 may execute the arithmetic processing with respect to the satellite signal in the L1 band, and the GNSS reception IC 20 may execute the arithmetic processing with respect to a signal strength of the wireless communication. Alternatively, the GNSS reception ICs 10 and 20 may execute the arithmetic processing with respect to satellite signals in the same frequency band.

Further, in each of the above-mentioned embodiments, the GNSS reception IC 10 executes positioning computation. However, the GNSS reception IC 20 may execute positioning computation. In such a case, the GNSS reception IC 20 may receive the satellite capture information generated by the baseband processing unit 15 of the GNSS reception IC 10, and the baseband processing unit 25 may demodulate the navigation message included in the baseband signal BB2, based on the received satellite capture information, and execute positioning based on the demodulated navigation message.

Further, in the above-mentioned embodiments, the GNSS reception IC 10 is a master, and the GNSS reception IC 20 is a slave. Alternatively, the GNSS reception IC 20 may be a master, and the GNSS reception IC 10 may be a slave. In other words, the control terminal PC1 of the GNSS reception IC 10 may be at a low level, and the control terminal PC2 of the GNSS reception IC 20 may be at a high level. In such a case, the GNSS reception IC 20 outputs the synchronization signal SyncO from the output terminal PO2, and the synchronization signal SyncO is input to the input terminal PI1 of the GNSS reception IC 10 and the input terminal PI2 of the GNSS reception IC 20. Further, in the communication between the CPU 17 of the GNSS reception IC 10 and the CPU 27 of the GNSS reception IC 20, the CPU 27 is operated as a master, and the CPU 17 is operated as a slave.

The above-described embodiments and modification example are merely examples and are not intended to be limiting. For example, the embodiments and modification example may be combined as appropriate.

The present disclosure includes configurations that are substantially the same as the configurations described in the embodiments, for example, configurations with the same functions, methods and results, or with the same advantages and effects. In addition, the present disclosure includes configurations obtained by replacing non-essential portions of the configurations described in the embodiments. In addition, the present disclosure also includes configurations that achieve the same effects as the configurations described in the embodiments or configurations that can achieve the same purposes. Further, the present disclosure includes configurations obtained by adding known techniques to the configurations described in the embodiments.

The following contents are derived from the embodiments and the modification example described above.

According to an aspect, a positioning device includes a first integrated circuit and a second integrated circuit, wherein the first integrated circuit includes a first reception unit configured to receive a first satellite signal transmitted from a satellite and converts the first satellite signal into a first intermediate frequency signal, a first conversion unit configured to convert the first intermediate frequency signal into a first baseband signal, a first baseband processing unit configured to process the first baseband signal, and a first control unit, the second integrated circuit includes a second reception unit configured to receive a second satellite signal transmitted from the satellite and convert the second satellite signal into a second intermediate frequency signal, a second conversion unit configured to convert the second intermediate frequency signal into a second baseband signal, and a second baseband processing unit configured to process the second baseband signal, and the first control unit switches the second reception unit, the second conversion unit, and the second baseband processing unit from an off state to an on state in accordance with a predetermined condition.

According to the positioning device, in accordance with the predetermined condition, the second reception unit, the second conversion unit, and the second baseband processing unit are switched from an off state to an on state. With this, the first integrated circuit and the second integrated circuit can collaborate to execute positioning. Further, according to the positioning device, when the second reception unit, the second conversion unit, and the second baseband processing unit are in an off state, the first integrated circuit solely executes positioning. Thus, the power consumption can be reduced, and the battery life of the battery can be expanded.

In an aspect of the positioning device, a frequency band of the second satellite signal may be lower than a frequency band of the first satellite signal.

According to the positioning device, the first integrated circuit and the second integrated circuit receive the satellite signals in the different frequency bands, and hence the satellite can be captured efficiently.

In an aspect of the positioning device, the first control unit may switch the second reception unit, the second conversion unit, and the second baseband processing unit from an on state to an off state in accordance with the predetermined condition.

According to the positioning device, the second reception unit, the second conversion unit, and the second baseband processing unit are switched from an on state to an off state in accordance with the predetermined condition. With this, the first integrated circuit solely executes positioning. Thus, the power consumption can be reduced, and the battery life of the battery can be expanded.

In an aspect, the positioning device may include a third integrated circuit configured to execute wireless communication with an external device, wherein, when communication strength of the wireless communication is a threshold value or less, the first control unit may switch the second reception unit, the second conversion unit, and the second baseband processing unit from an off state to an on state.

According to the positioning device, when the communication strength is not satisfactory, the second reception unit, the second conversion unit, and the second baseband processing unit are switched from an off state to an on state. With this, the first integrated circuit and the second integrated circuit can collaborate to execute positioning, and hence the probability of successful positioning is increased.

In an aspect, the positioning device may include a third integrated circuit configured to execute wireless communication with an external device, wherein, when communication strength of the wireless communication is more than the threshold value, the first control unit may switch the second reception unit, the second conversion unit, and the second baseband processing unit from an on state to an off state.

According to the positioning device, when the communication strength is satisfactory, the second reception unit, the second conversion unit, and the second baseband processing unit are switched from an on state to an off state. With this, the first integrated circuit solely execute positioning. Thus, the battery life of the battery can be expanded.

In an aspect of the positioning device, when a remaining level of a battery shared by the first integrated circuit and the second integrated circuit is a threshold value or more, the first control unit may switch the second reception unit, the second conversion unit, and the second baseband processing unit from an off state to an on state.

According to the positioning device, when the remaining level of the battery is high, the second reception unit, the second conversion unit, and the second baseband processing unit are switched from an off state to an on state. With this, the first integrated circuit and the second integrated circuit can collaborate to execute positioning, and hence the probability of successful positioning is increased.

In an aspect of the positioning device, when a remaining level of a battery shared by the first integrated circuit and the second integrated circuit is less than the threshold, the first control unit may switch the second reception unit, the second conversion unit, and the second baseband processing unit from an on state to an off state.

According to the positioning device, when the remaining level of the battery is low, the second reception unit, the second conversion unit, and the second baseband processing unit are switched from an on state to an off state. With this, the first integrated circuit solely execute positioning. Thus, the battery life of the battery can be expanded.

In an aspect of the positioning device, the first integrated circuit may switch the second reception unit, the second conversion unit, and the second baseband processing unit from an off state to an on state, and then may transmit, to the second integrated circuit, a synchronization signal for synchronizing a first timing signal for controlling operation timing of the first conversion unit and a second timing signal for controlling operation timing of the second conversion unit of the second integrated circuit.

According to the positioning device, due to the synchronization signal, the timing at which the first integrated circuit receives the first satellite signal to extract the first baseband signal and the timing at which the second integrated circuit receives the second satellite signal to extract the second baseband signal can be synchronized. Therefore, according to the positioning device, the first integrated circuit and the second integrated circuit can collaborate to search for the satellite efficiently. Thus, power saving and time reduction during the search are achieved.

In an aspect of the positioning device, the second baseband processing unit may generate satellite capture information including a frequency offset and a code phase of the second satellite signal, based on the second baseband signal, the second integrated circuit may transmit the satellite capture information to the first integrated circuit, the first integrated circuit may receive the satellite capture information, and the first baseband processing unit may demodulate a navigation message included in the first baseband signal, based on the satellite capture information, and may execute positioning based on the navigation message.

According to the positioning device, the first integrated circuit can execute positioning for a short period of time by utilizing the satellite capture information generated by the second integrated circuit.

What is claimed is:

1. A positioning device comprising:
a first integrated circuit; and
a second integrated circuit, wherein
the first integrated circuit includes:
a first reception unit configured to receive a first satellite signal transmitted from a satellite and converts the first satellite signal into a first intermediate frequency signal;
a first conversion unit configured to convert the first intermediate frequency signal into a first baseband signal;
a first baseband processing unit configured to process the first baseband signal; and
a first control unit,
the second integrated circuit includes:
a second reception unit configured to receive a second satellite signal transmitted from the satellite and convert the second satellite signal into a second intermediate frequency signal;
a second conversion unit configured to convert the second intermediate frequency signal into a second baseband signal; and
a second baseband processing unit configured to process the second baseband signal, and
the first control unit switches the second reception unit, the second conversion unit, and the second baseband processing unit from an off state to an on state in accordance with a predetermined condition.

2. The positioning device according to claim 1, wherein
a frequency band of the second satellite signal is lower than a frequency band of the first satellite signal.

3. The positioning device according to claim 2, wherein
the first control unit switches the second reception unit, the second conversion unit, and the second baseband processing unit from an on state to an off state in accordance with the predetermined condition.

4. The positioning device according to claim 3, comprising:
a third integrated circuit configured to execute wireless communication with an external device, wherein
when communication strength of the wireless communication is a threshold value or less, the first control unit switches the second reception unit, the second conversion unit, and the second baseband processing unit from an off state to an on state.

5. The positioning device according to claim 4, wherein
when the communication strength of the wireless communication is more than the threshold value, the first control unit switches the second reception unit, the second conversion unit, and the second baseband processing unit from an on state to an off state.

6. The positioning device according to claim 2, wherein
when a remaining level of a battery shared by the first integrated circuit and the second integrated circuit is a threshold value or more, the first control unit switches the second reception unit, the second conversion unit, and the second baseband processing unit from an off state to an on state.

7. The positioning device according to claim 6, wherein
when the remaining level of the battery shared by the first integrated circuit and the second integrated circuit is less than the threshold, the first control unit switches the second reception unit, the second conversion unit, and the second baseband processing unit from an on state to an off state.

8. The positioning device according to claim 5, wherein
the first integrated circuit switches the second reception unit, the second conversion unit, and the second baseband processing unit from an off state to an on state, and then transmits, to the second integrated circuit, a synchronization signal for synchronizing a first timing signal for controlling operation timing of the first conversion unit and a second timing signal for controlling operation timing of the second conversion unit of the second integrated circuit.

9. The positioning device according to claim 8, wherein
the second baseband processing unit generates satellite capture information including a frequency offset and a code phase of the second satellite signal, based on the second baseband signal,
the second integrated circuit transmits the satellite capture information to the first integrated circuit,
the first integrated circuit receives the satellite capture information, and
the first baseband processing unit demodulates a navigation message included in the first baseband signal, based on the satellite capture information, and executes positioning based on the navigation message.
